(19) United States
(12) Patent Application Publication
(10) Pub. No.: US 2022/0061065 A1
(43) Pub. Date: Feb. 24, 2022

(54) UPLINK TRANSMISSIONS USING UNLICENSED FREQUENCY SPECTRUM

(71) Applicant: Telefonaktiebolaget LM Ericsson (publ), Stockholm (SE)

(72) Inventors: Min Wang, Luleå (SE); Jinhua Liu, Beijing (CN)

(21) Appl. No.: 17/299,690

(22) PCT Filed: Oct. 30, 2019
(86) PCT No.: PCT/CN2019/114489

§ 371 Date: Jun. 3, 2021

(30) Foreign Application Priority Data
Dec. 3, 2018 (CN) PCT/CN2018/118949

(51) Int. Cl. H04W 72/12; H04W 16/14

(52) U.S. Cl. CPC H04W 72/1242; H04W 72/1252; H04W 16/14

(57) ABSTRACT

Embodiments described herein provide methods and apparatus for transmitting an uplink transmission to a base station using an unlicensed frequency spectrum. The method performed by a wireless device comprises determining whether the uplink transmission comprises an urgent uplink transmission or a non-urgent uplink transmission; responsive to the uplink transmission comprising an urgent uplink transmission, transmitting the uplink transmission to the base station; and responsive to the uplink transmission comprising a non-urgent uplink transmission, transmitting the non-urgent uplink transmission responsive to receiving a network scheduling message from the base station, wherein the network scheduling message indicates that the wireless device is scheduled for transmission of the non-urgent uplink transmission.

### TECHNICAL FIELD

Embodiments described herein relate to methods and apparatus for uplink transmission using an unlicensed frequency spectrum.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Uplink orthogonality may be achieved between user equipments (UEs) communicating with a base station (for example in a single cell) by ensuring the transmissions from the different UEs in are timing-aligned when received by the base station (e.g. gNB). In this way, the intra-cell interference between UEs may be minimized. The timing alignment may be implemented by applying a timing advance (TA) on each UE transmitted uplink sub-frame, relative to the received downlink sub-frame at that UE. The TA may be considered as a negative offset, which means that the uplink transmitted sub-frame having the TA adjustment, may be transmitted in advance compared to the received downlink sub-frame. In theory, the TA value may be equal to twice the propagation delay between the base station and the UE assuming that the same propagation delay value applies to both downlink and uplink directions.

FIG. 1 illustrates how TA may be applied to an Uplink (UL) transmission. In FIG. 1, two UEs, UE1 and UE2 are located in a cell communicating with a base station (e.g. a gNB). In this example, UE1 is closer to gNB that UE2. The downlink (DL) propagation delay between the gNB and UE1 is denoted as Dp1, and the DL propagation delay between the gNB and UE2 is denoted as Dp2. Since UE1 is closer to the gNB than UE2,

Dp1<Dp2 (1)

In practice, upon the reception of an uplink signal from a UE the gNB may measure the timing of the uplink signal arrival, and may compare the measured arrival time with the desired arrival time to determine the timing advance for a UE.

The gNB may then transmit a timing advance command to the UE. Upon the reception of the time advance command, the UE may adjust its uplink transmission timing accordingly.

Via such procedure, the transmissions from UE1 and UE2, (i.e. UL sub-frames n) may be ensured to be received by gNB at the same time (i.e. the middle dash vertical line).

According to the Long Term Evolution (LTE) 3GPP standard, TAs may take values within the range (0-0.67 ms with a granularity of 0.52 us). For example, a TA value of 0.52 us, may correspond to a propagation distance between gNB and UE of (3×10⁸×0.52×10⁻⁶)/2=78 m. While for TA value of 0.67 ms, the corresponding propagation distance between gNB and UE may be (3×10⁸×0.67×10⁻³)/2=100 km, which may therefore be a maximum propagation distance. The maximum propagation distance in this example may therefore facilitate a cell radius of up to 100 km.

The random access may be initiated with obtained system information for several purposes including for example:
1) An initial radio link establishment which moves the user equipment from the RRC IDLE status to an RRC connected status.
2) A re-establishment of the radio link if a radio link failure is triggered
3) An uplink synchronization between the user equipment and the network, for example, a timing advance (TA) value may be estimated by the network based on a PRACH transmission by a UE, and feedback to the UE (included in the random access response message) for the UE to then adjust the uplink timing.

As mentioned above, the initial UL synchronization between UE and the network may be obtained via a Random Access Channel (RACH) access procedure. After that, when the UE is in active mode, the base station may continuously measure the timing of uplink signal (for example, via the Physical Uplink Shared Channel (PUSCH), the Physical Uplink Control Channel (PUCCH) or a Sounding Reference Signal (SRS)) transmitted from each UE, and may adjust the uplink transmission timing advance if necessary. The TA adjustment may be sent by network or base station using Media Access Control (MAC) Control Element.

The TA updates may be induced by:
1) The movement of a UE, leading to the changes of the propagation delay depending primarily on the distance of the UE from the base station.
2) The changes of the propagation paths, for example, some paths may disappear, and some new ones may arise, causing changes to the propagation delay.
3) Oscillator drift in the UE, where the accumulation of small frequency errors over time may result in timing errors; and/or
4) Doppler shift arising from the UE movement, resulting in an additional frequency offset of the uplink signals received at the base station.

Next generation systems may be expected to support a wide range of use cases with varying requirements ranging from fully mobile devices to stationary Internet of Things (IoT) or fixed wireless broadband devices. The traffic pattern associated with many use cases may be expected to consist of short or long bursts of data traffic with varying length of waiting period in between (here called an inactive state). In New Radio (NR), both license assisted access and standalone unlicensed operation are to be supported in 3GPP. Beam failure detection and handling procedure, which is specific for NR to handle the beam mismatch between the peer radio nodes for wireless communication, may be investigated considering the availability status. In the following, a channel sensing scheme based on Listen Before Talk (LBT), radio link monitoring procedure and beam failure recovery procedures are introduced as a basis to address the solutions.

For a node (e.g., For NR-U a gNB or UE, For LTE-LAA a gNB or UE, or for Wi-Fi an AP or STA)) to be allowed to transmit in unlicensed frequency spectrum (e.g., 5 GHz band) it may needs to perform a clear channel assessment (CCA). This procedure typically includes sensing the medium to be idle for a number of time intervals. Sensing the medium to be idle may be done in different ways, e.g. using energy detection, preamble detection or using virtual carrier sensing. Virtual carrier sensing may imply that the node reads control information from other transmitting nodes informing when a transmission ends. After sensing the medium to be idle, the node may be allowed to transmit for a certain amount of time, sometimes referred to as transmission opportunity (TXOP). The length of the TXOP may depend on regulation and a type of CCA that has been performed, but may, for example, range from 1 ms to 10 ms. This duration may be referred to as a COT (Channel Occupancy Time).

Channel sensing may be needed before a transmitter starts to transmit. Depending on different situations, different LBT parameters may be applied. The LBT parameters may be different for:
different transmit signals such as DRS, paging message, PRACH, PUCCH, SRS, PDCCH, PUSCH/PDSCH;
different maximum channel occupation time (MCOT) configuration;
different services, e.g. high priority services may perform LBT with short LBT;
based on whether it is an initial Transmission of a MCOT or a start transmission of a transmitter within a MCOT.

In order to ensure the critical functionality of a wireless communication network, higher priority may be assigned for transmissions for some control channels such as DRS, paging, PRACH etc via proper LBT parameter settings. For instance, only short LBT intervals may be used for DRS or PRACH transmissions.

FIG. 2 illustrates an example of MOOT sharing. Within the same MOOT, it may be anticipated that for NR in unlicensed bands (NR-U), a small gap to accommodate for the radio turnaround time will be allowed between downlink and uplink transmissions. For example, this may enable the transmission of PUCCH carrying UCI feedback as well as PUSCH carrying data and possible UCI within the same transmit opportunity (TXOP) acquired by the base station initiating the transmission, without the UE performing a clear channel assessment before responding with an UL PUSCH/PUCCH transmission, as long as the gap between DL and UL transmission is less than or equal to, for example, 16 us, and/or short LBT (16+9 us) is performed if, for example, the gap is longer than 16 us while less than 25 us. Operation in this manner is may be called “COT sharing.”

The lack of full controllability of the radio channel may impact virtually every aspect of the network's operations involving radio interface transmissions. Embodiments described herein address the random access blocking problem, and the relevant solutions.

There currently exist certain challenge(s). There may be potential blocking of a LBT period in one UE due to a TA difference between FDM'd PUSCH, PUCCH, and PRACH transmissions from a different UE communicating with the base station.

Unlicensed NR (NR-U) may support a common interlace structure for uplink RS and physical channels, including PUSCH, PUCCH, associated DMRS, and potentially PRACH.

For a UE in Idle state, the UE may first obtain the downlink alignment first via reading the synchronization signal (PSS and SSS carried in the SSB block). Via detection of the PSS transmission, the UE may obtain frequency layer synchronization, and identify the slot boundary. In addition, the physical cell ID may also be detected at this stage. Furthermore, via detection of the SSS transmission, the UE may identify the radio frame timing and the group cell id.

For uplink synchronization, uplink orthogonality may be achieved by ensuring the transmissions from different UEs in the same cell are timing-aligned received by gNB. In this manner, the intra-cell interference between UEs may be avoided. The timing alignment may be implemented by applying a timing advance (TA) at the uplink transmission from UE, as described previously, relative to the received downlink sub-frame. The initial uplink timing alignment may be obtained via a RACH procedure. The base station, may receive a PRACH preamble and measures the timing accuracy from this UE. After that, a TA value can be provided to the UE via a Random Access Response (RAR) message. The UE may adjust its uplink timing accordingly.

Therefore, for a UE in RRC idle which has not obtained uplink synchronization, or a UE in RRC connected, where the uplink synchronization has been lost, a Random Access (RA) maybe initiated for these UEs in order to obtain or update uplink timing advance values.

In this example scenario, the occurrence of LBT blocking may be due to below reasons:

1) The downlink timing measurement inaccuracy by different UEs may be different;

2) The timing maintenance performance by different UEs may be different; and

3) The radio propagation paths among UEs may be different from the one between the gNB and the UEs, therefore, a UE may not finish its LBT when the radio signal transmitted by another UE reaches this UE. If the PRACH transmission (or other transmissions such as SRS, PUCCH or PUSCH) of a first UE reaches a second UE before the second UE finishes its LBT, it may result in LBT failure for the second UE and the transmission of the second UE may be blocked even though it may be that the transmission of the second UE may be multiplexed (in code/frequency domain) with the PRACH transmission of the first UE effectively.

The PRACH transmissions intended for UL synchronization from one UE may therefore block other transmissions from other UEs including PUSCH, PUSCH and PRACH. There are several issues expected.

For example:

Issue 1: RA intended for UL sync of a UE may block transmissions of other UEs;

Issue 2: an early starting PUCCH/PUSCH transmission from a UE may block the PUCCH/PUSCH transmission of another UE though the two PUCCHs/PUSCHs use different frequency resources in the same slot, which may lead to inefficiency for frequency multiplexing;

Issue 3: for MU-MIMO an early starting PUSCH from a UE may block the PUSCH from the paired UE, which may lead to inefficiency for spatial multiplexing.

Issue 4: A transmission with a large TA (in advance of its received DL subframe) may block adjacent later transmission opportunity.

FIG. 3 illustrates an example of uplink transmissions with and without UL synchronization.

For a UE with uplink synchronization, the UE may be required to perform an uplink transmission with TA adjustment, meaning that the uplink transmission takes places in advance (for example, twice the propagation delay in advance) compared to its received downlink sub-frame. So, a UE may start a transmission at a time duration of TA in advance of a subframe N, after sensing the subframe N as idle. During this time advancement period, the other UEs may then sense the subframe N as busy and may therefore not perform transmissions. However, these UEs may still be able to perform transmissions effectively since there is UL orthogonality among UEs in the same cell. Therefore, it is necessary to study the above issues and propose solutions to address them accordingly.

### SUMMARY

According to some embodiments there is provided a method in a wireless device for transmitting an uplink transmission to a base station using an unlicensed frequency spectrum. The method comprises determining whether the uplink transmission comprises an urgent uplink transmission or a non-urgent uplink transmission; responsive to the uplink transmission comprising an urgent uplink transmission, transmitting the uplink transmission to the base station, particularly after a successful LBT; and responsive to the uplink transmission comprising a non-urgent uplink transmission, transmitting the non-urgent uplink transmission responsive to receiving a network scheduling message from the base station, wherein the network scheduling message indicates that the wireless device is scheduled for transmission of the non-urgent uplink transmission.

This therefore provides mechanisms to differentiate between urgent and non-urgent transmissions, for example according to their associated QoS requirements to achieve a balance between the expected QoS fulfillment and the decrease/avoidance of the LBT blocking, for example, due to different TA differences between wireless devices and frequency division multiplexed PUCCH, PUSCH and PRACH transmissions.

The embodiments described herein therefore reduce a probability of LBT blocking or avoid LBT blocking entirely so that the system capacity and the resource utilization is increased. Furthermore, the QoS requirements for high priority RA/PUCCH signaling may be better satisfied.

In some embodiments, the step of determining comprises determining that the uplink transmission comprises an urgent uplink transmission responsive to the uplink transmission being triggered by a Radio Link Failure, a handover or a beam failure recovery, BFR.

In some embodiments the network scheduling message indicates that the wireless device is scheduled for transmission of the non-urgent uplink transmission by identifying a group of wireless devices, wherein the wireless device belongs to the group of wireless devices. By grouping the wireless devices, the base station may schedule wireless devices having similar timing advance values together, thereby avoiding LBT blocking between wireless devices in the same group.

In some embodiments the method further comprises responsive to the uplink transmission comprising a non-urgent uplink transmission, and responsive to not receiving a network scheduling message indicating that the wireless device is scheduled for transmission of the non-urgent uplink transmission in a predetermined time period, transmitting the non-urgent uplink transmission. This embodiment may therefore avoid non-urgent transmissions being delayed unnecessarily.

According to some embodiments there is provided a method in a base station for receiving an uplink transmission from at least one wireless device communicating with the base station using an unlicensed frequency spectrum. The method comprising: transmitting a network scheduling message to a first wireless device, wherein the network scheduling message indicates that the first wireless device is scheduled for transmission of the non-urgent uplink transmission; responsive to transmitting the network scheduling message receiving the non-urgent uplink transmission from the first wireless device.

In some embodiments the network scheduling message indicates that the first wireless device is scheduled for transmission of the non-urgent uplink transmission by identifying a group of wireless devices, wherein the first wireless device belongs to the group of wireless devices. In some embodiments the method further comprises determining one or more groups of wireless devices to configure based on a load on the base station. In other words, the number of groups may relate to the load on the base station such that more groups may be configured when the load is high in order to avoid LBT blocking, whilst avoiding configuring unnecessary groups when the load on the base station is lower.

### BRIEF DESCRIPTION OF THE DRAWINGS

FIG. 1 illustrates how TA may be applied to an Uplink (UL) transmission;

FIG. 2 illustrates an example of MOOT sharing;

FIG. 3 illustrates an example of uplink transmissions with and without UL synchronization;

FIG. 4 illustrates a method in accordance with some embodiments;

FIG. 5 illustrates a method in a base station for receiving an uplink transmission from at least one wireless device communicating with the base station using an unlicensed frequency spectrum;

FIG. 6 illustrates a wireless network in accordance with some embodiments;

FIG. 7 illustrates a User Equipment in accordance with some embodiments;

FIG. 8 illustrates a Virtualization environment in accordance with some embodiments;

FIG. 9 illustrates a Telecommunication network connected via an intermediate network to a host computer in accordance with some embodiments;

FIG. 10 illustrates a Host computer communicating via a base station with a user equipment over a partially wireless connection in accordance with some embodiments;

FIG. 11 illustrates methods implemented in a communication system including a host computer, a base station and a user equipment in accordance with some embodiments;

FIG. 12 illustrates methods implemented in a communication system including a host computer, a base station and a user equipment in accordance with some embodiments;

FIG. 13 illustrates methods implemented in a communication system including a host computer, a base station and a user equipment in accordance with some embodiments;

FIG. 14 illustrates methods implemented in a communication system including a host computer, a base station and a user equipment in accordance with some embodiments;

FIG. 15 illustrates a virtualization apparatus in accordance with some embodiments; and

FIG. 16 illustrates a virtualization apparatus in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

To decrease and/or avoid the LBT blocking due to different TA differences between UEs and Frequency division multiplexed or code multiplexed PUCCH, PUSCH and PRACH transmissions, embodiments described herein support configurable transmission options for Random Access (RAs) especially for RAs intended for UL synchronization obtainment/update.

A UE may transmit a triggered uplink transmission (e.g. a PRACH transmission) immediately with the available resources, after the triggering of this uplink transmission is triggered by an event of high priority, e.g. Radio Link Failure (RLF), Handover (HO) or beam failure recovery (BFR) meaning that the uplink transmission is delay critical, or urgent.

For a non-urgent uplink transmission, the UE may wait to transmit the triggered uplink transmission until reception of a corresponding network scheduling message from the base station. If the UE has not received the network scheduling message after a configured time since the non-urgent uplink transmission is triggered, the UE may send a request message in another uplink procedure (for example an urgent uplink transmission) to request for scheduling of the non-urgent uplink transmission.

The base station (e.g. gNB), may configure if the network scheduling is enabled or disabled. The configuration may be cell specific or UE specific, or RA event specific. The configuration may be signaled to a UE via system information, dedicated Radio Resource Control (RRC) signaling, MAC Control Event (CE), downlink control information (DCI), or Physical Downlink Control Channel (PDCCH) order.

This embodiments described herein propose mechanisms to differentiate RA and Physical Uplink Control Channel (PUCCH) transmissions according to their associated Quality of Service (QoS) requirements to achieve a good balance between the expected QoS fulfillment and to decrease/avoid LBT blocking due to different TA differences between UEs and FDMed PUCCH, PUSCH and PRACH transmissions.

The LBT blocking probability between FDMed PUCCH, PUSCH, and PRACH transmissions are reduced/avoided so that the system capacity and the resource utilization is increased. The QoS requirements for high priority RA/PUCCH signaling are better satisfied.

The below embodiments are described in the context of NR unlicensed spectrum (NR-U). However, it will be appreciated that the embodiments are not limited to NR-U scenarios, they are also applicable to other unlicensed operation scenarios such as LTE Licensed Spectrum Access (LAA) enhanced LAA (eLAA) and further enhanced LAA (feLAA).

The LBT schemes for PRACH and PUCCH are also described in below embodiments in order to avoid the LBT blocking issue.

The configurable LBT schemes may comprise at least one of the below not limiting example LBT categories (also referred to as Type 1 or Type 2 channel access in 3GPP spec, e.g., TS 36.213-f00):
Category 1: No LBT;
Category 2: LBT without random back-off;
Category 3: LBT with random back-off with a fixed size of contention window;
Category 4: LBT with random back-off with a variable size contention window;

Specifically for Category 4 LBT, to provide differentiation to channel access priorities based on the type of traffic served (e.g. Voice over Internet Protocol (VoIP), video, best effort, or background), four LBT priority classes are defined with different contention window sizes (CWS) and MOOT. The MOOT is a time after the transmitter has gained access to the channel during which the transmitter is allowed to transmit. Table 1 summarizes the MOOT and CWS for the downlink channel access priority classes, while Table 2 summarizes the MOOT and CWS for the uplink channel access priority classes. Both tables are abstracted from the Table 15.1.1-1 and the Table 15.2.1-1 in the spec 3GPP TS 36.213 V15.1.0.

In embodiments described herein, we apply the same channel access priority class for LBT operations as for RACH and PUCCH transmissions. However, the channel access priority classes may be defined differently and are not limited to above examples.

TABLE 15.1.1-1
Channel Access Priority Class

| Channel | | |
|---|---|---|
| Access | | |
| Priority | | allowed |
| Class | MCOT | CWS sizes |
| 1 | 2 ms | {3, 7} |
| 2 | 3 ms | {7, 15} |
| 3 | 8 or 10 ms | {15, 31, 63} |
| 4 | 8 or 10 ms | {15, 31, 63, 127, |
| | | 255, 511, 1023} |

TABLE 15.2.1-1
Channel Access Priority Class for UL

| Channel | | |
|---|---|---|
| Access | | |
| Priority | | allowed |
| Class | MCOT | CWS sizes |
| 1 | 2 ms | {3, 7} |
| 2 | 4 ms | {7, 15} |
| 3 | 6 ms or 10 ms | {15, 31, 63, 127, |
| | | 255, 511, 1023} |
| 4 | 6 ms or 10 ms | {15, 31, 63, 127, |
| | | 255, 511, 1023} |

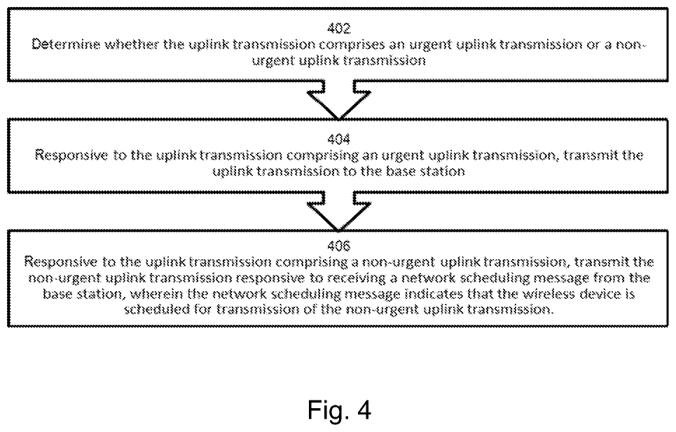

FIG. 4 illustrates a method in accordance with some embodiments. The method in FIG. 4, may be performed by a wireless device (or UE) for transmitting an uplink transmission to a base station using an unlicensed frequency spectrum.

In step 402, the wireless device determines whether the uplink transmission comprises an urgent uplink transmission or a non-urgent uplink transmission.

In step 404, responsive to the uplink transmission comprising an urgent uplink transmission, the wireless device transmits the uplink transmission to the base station. In particular, the uplink transmission is transmitted after a successful LBT operation.

In step 406, responsive to the uplink transmission comprising a non-urgent uplink transmission, the wireless device transmits the non-urgent uplink transmission responsive to receiving a network scheduling message from the base station, wherein the network scheduling message indicates that the wireless device is scheduled for transmission of the non-urgent uplink transmission.

In other words, in order to reduce random occurrence of RA transmissions in the time domain so as to reduce the occurrence of LBT blocking due to different uplink timing advance values, and to improve the multiplexing of PRACH transmissions among different wireless devices, a wireless device is allowed to delay a non-urgent uplink transmission until receiving a network scheduling message, where the scheduling message may carry scheduling indicators for a group of wireless devices. At the same time, for an urgent uplink transmission, the wireless device may follow the existing wireless device initiated RA procedure, and may for example, select the next available RA occasion, and may transmit the RA immediately.

In some examples, step 402 comprises determining whether the uplink transmission comprises an urgent uplink transmission or a non-urgent uplink transmission based on one or more of: a global indication of an application type, a logical channel priority of the uplink transmission, a quality class indicator of the uplink transmission, and a physical location of the wireless device.

For example, for Idle UEs, typical events are initial access or requesting System Information SI. There may be limited ways to define priorities of data (the data that triggers the initial access) but for example an Application ID or some other global indication of application type may be used. Typically, each app running on for example, Android or IOS, has an application id (=OS specific application ID identifier) assigned by the app developer. The UE's access class or access category which is typically used for the initial access control, e.g., access barring, may be also applied here to replace Application ID.

For example, for UEs in RRC connected state, the priorities of data (the data that triggers the uplink transmission) may be based on the Logical Channel (LCH) priority of the LCH containing data. The other identifiers, like the Cell Radio Network Temporary Identifier (C-RNTI), Configured Scheduling Radio Network Temporary Identifier (CS-RNTI), the radio bearer identification, logical channel group identification, or session/flow identification (e.g., 5G Quality of Service indicator (5QI), or QoS Flow Identity (QFI) in NR network, while Quality Class Identifier (QCI) in LTE network) may be also applicable.

In some examples, step 402 may comprise determining that the uplink transmission comprises an urgent uplink transmission responsive to the uplink transmission being triggered by a Radio Link Failure, a handover or a Beam Failure Recovery (BFR).

In some examples, the network scheduling message indicates that the wireless device is scheduled for transmission of the non-urgent uplink transmission by identifying the wireless device. In other words, the network scheduling message comprises UE IDs that are scheduled/paged/polled for uplink transmissions if UE IDs are known

In some examples, the network scheduling message indicates that the wireless device is scheduled for transmission of the non-urgent uplink transmission by identifying a group of wireless devices, wherein the wireless device belongs to the group of wireless devices. In other words, the network scheduling message may comprise a one or more RA Group identifiers that is being scheduled/paged/polled for RA transmissions.

In some examples, the network scheduling message indicates that the wireless device is scheduled for transmission of the non-urgent uplink transmission by identifying a type of uplink transmission, wherein the non-urgent uplink transmission is of the type of uplink transmission. In other words, the network scheduling message may comprise an indication of RA types that are scheduled/paged/polled for RA transmissions

In some examples, the network scheduling message indicates a Listen Before Talk, LBT, category for the wireless device to use before transmitting the non-urgent uplink transmission.

In some examples, the network scheduling message indicates LBT parameters associated with the LBT category. For example, the LBT parameters may comprise the LBT option and/or the duration of the MOOT for base station initiated signaling transmission.

The network signaling message may also indicate future or coming RA occasions for other RA groups/RA types

For a non-urgent uplink transmission therefore, the wireless device may wait until reception of a network scheduling signaling indicating that the transmission of this type or group of wireless devices is allowed. After that, the wireless device may initiate the uplink transmission resources that are assigned by the network scheduling message, or with resources that are already configured in advance of the uplink transmission triggering event. If the RA type/group that network scheduling message carries doesn't match the triggered RA type in the wireless device, the wireless device may wait for next network scheduling message.

In some examples, the method further comprises responsive to the uplink transmission comprising a non-urgent uplink transmission, and responsive to not receiving a network scheduling message indicating that the wireless device is scheduled for transmission of the non-urgent uplink transmission in a predetermined time period, transmitting the non-urgent uplink transmission. In other words, after waiting a predetermined time after the non-urgent uplink transmission is triggered, the wireless device may utilize existing wireless device initiated RA procedure (i.e., select the next available RA occasions, and transmits the RA immediately).

In some examples, the method further comprises responsive to the uplink transmission comprising a non-urgent uplink transmission, and to not receiving a network scheduling message indicates that the wireless device is scheduled for transmission of the non-urgent uplink transmission, transmitting a request for scheduling as part of an urgent uplink transmission from the wireless device. The wireless device may then receive a network scheduling message indicating that the wireless device should transmit the non-urgent uplink transmission responsive to the request, and may transmit the non-urgent uplink transmission accordingly.

In other words, if the wireless device has also triggered an urgent uplink transmission, the wireless device may carry a request message in this RA procedure (e.g., in Msg3) to request that the base station to schedule RA transmission for the non-urgent uplink transmission.

In some examples, the wireless device may not be required to monitor the network scheduling message if there is no need for uplink transmissions in order to save power.

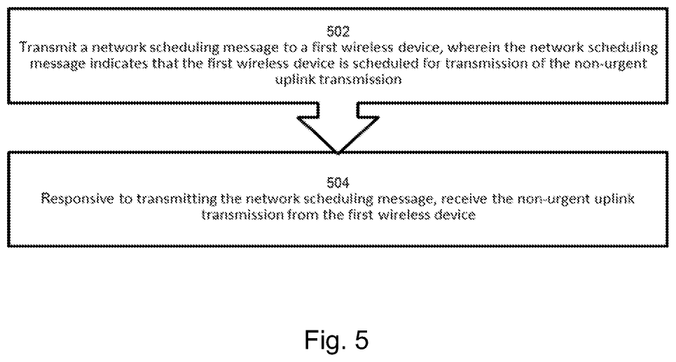

FIG. 5 illustrates a method in a base station for receiving an uplink transmission from at least one wireless device communicating with the base station using an unlicensed frequency spectrum.

In step 502, the base station transmits a network scheduling message to a first wireless device (for example, as described above with reference to FIG. 4), wherein the network scheduling message indicates that the first wireless device is scheduled for transmission of the non-urgent uplink transmission.

In step 504, the base station, responsive to transmitting the network scheduling message, receives the non-urgent uplink transmission from the first wireless device.

As described previously, in some examples, the network scheduling message indicates that the wireless device is scheduled for transmission of the non-urgent uplink transmission by identifying a group of wireless devices, wherein the wireless device belongs to the group of wireless devices. The wireless device's timing may be considered in the RA/UE grouping procedure. For wireless devices in RRC connected and with valid uplink alignment, the wireless devices with similar uplink timing advance values may be configured in the same group for network scheduling message purposes. For wireless devices in RRC idle or UEs in RRC connected without valid uplink alignment, i.e., UEs that have lost uplink sync, the wireless devices physical location such as GPS position may be considered in the group configuration.

For example, the base station may configure one or more groups of wireless devices based on timing advance values for the at least one wireless device communicating with the base station.

In some examples, the base station may determine one or more groups of wireless devices to configure based on a load on the base station. In other words, the number of groups that are configured by the base station may depend on the measured system load/channel occupancy. In one example, one single group including all wireless devices and all RA types may be configured in case the system is lowly loaded, or there is low channel occupancy. In this case, it may be sufficient for the wireless device to transmit PRACH without LBT for RA, and in this example there may be no need to activate the network scheduling message. In another example, multiple groups can be configured in case the system is high loaded, or there is high channel occupancy. In this case, a wireless device may transmit RA events requiring low latency or higher QoS priority directly upon triggering of the RA event, if there are available RA resources. At the same time, a wireless device may transmit RA events with long latency requirement or lower QoS priorities only in case the wireless device has received at least one network scheduling message from the base station. A wireless device may be in multiple groups in order to facilitate the network scheduling by the network.

In some embodiments the method of FIG. 5 may therefore further comprise transmitting an indication of the configured groups of wireless devices to the at least one wireless device communicating with the base station.

In some examples, multiple groups may be configured in order to improve the multiplexing for PRACH transmissions, so that multiple PRACH transmissions can multiplexed in the same time period in the same channel. A wireless device may randomly select a group to join if there is no dedicated group assigned by the base station to the wireless device.

Each group of wireless devices may be associated with a unique group ID. For each group, the base station may configure the option that the associated RA events may be transmitted. Each group may be also configured with different RA resources.

The network scheduling message may also comprise one or several group indices which can trigger a group of UEs/RA events to transmit. Such RA events are typically configured in a group associated with long delay requirements or lower priorities.

In some examples, the base station may transmit network scheduling messages periodically.

In some examples, the base station may transmit the network scheduling message responsive to receiving a request for scheduling from the first wireless device as part of a Msg3 in a random access procedure.

In some examples, the base station may transmit network scheduling messages responsive to a wireless device needing to be scheduled.

In some examples, the base station may transmit the network scheduling message as part of one of: a paging message, PDCCH signaling, RRC signaling or MAC CE.

In some examples, the network scheduling message may reuse a paging message, or a PDCCH signaling addressed to specific configurable control resource sets (CORESETS), or PDCCH search spaces, or specific RNTIs/group identifiers. The network scheduling message may be a MAC CE, or a RRC signaling message.

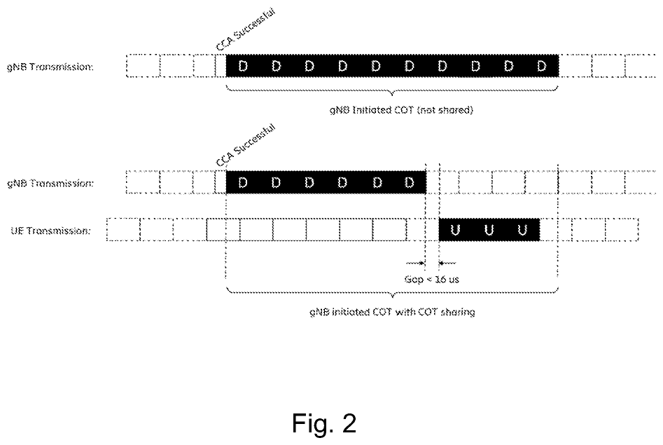

In some examples, to avoid RA transmissions (e.g., RA intended for obtainment or update of uplink alignment) to be blocked by other transmissions such as PUCCH transmission or PUSCH transmissions, which are frequency division multiplexed with RA transmissions, the base station may configure the RA transmissions with no LBT option, the no LBT option is indicated in a network scheduling message. In this case, the scheduled RA transmissions may be within the base station initiated COT (for example as illustrated in FIG. 2), meaning that gap in time domain between the start position of scheduled RA occasions and the end of the DL transmission may be less than 16 us. Since the scheduled RA transmissions may not be delay sensitive, the base station can schedule the RA transmissions in such a way as to leave sufficient preparation time for the scheduled wireless devices.

In some examples, the base station may enable or disable the network scheduling based on a load on the base station. The network scheduling may be enabled or disabled on a cell specific, wireless device specific, or RA event specific level. The configuration may be signaled to a wireless device via system information, dedicated RRC signaling, MAC CE, or DCI/PDCCH order.

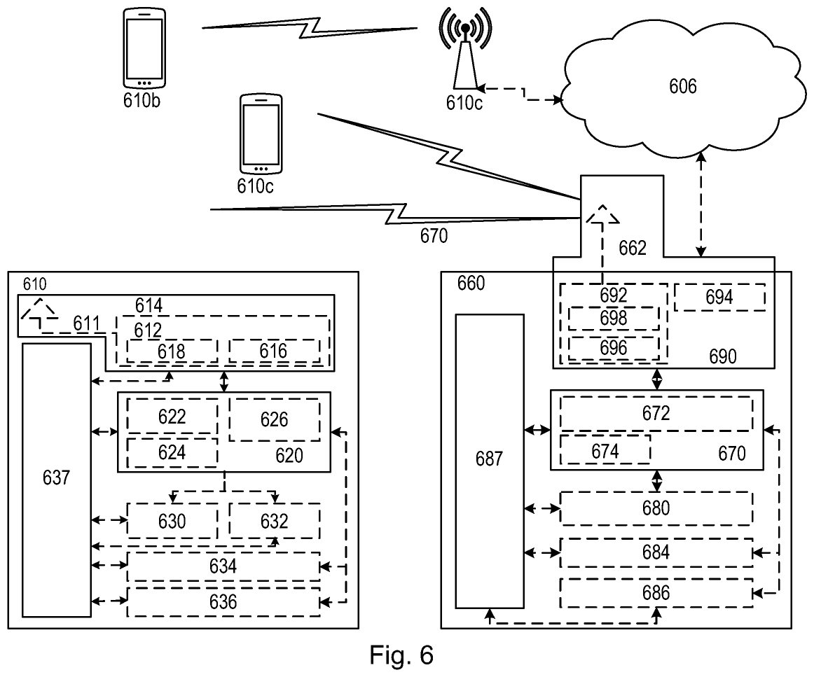

FIG. 6 illustrates a wireless network in accordance with some embodiments.

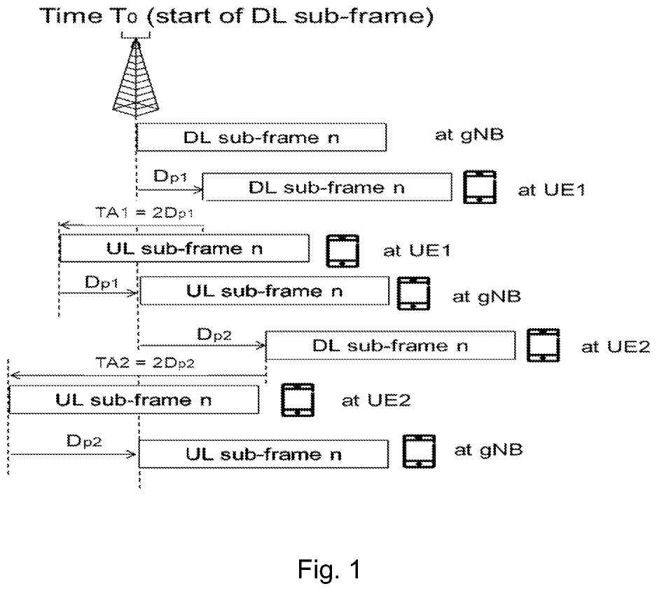

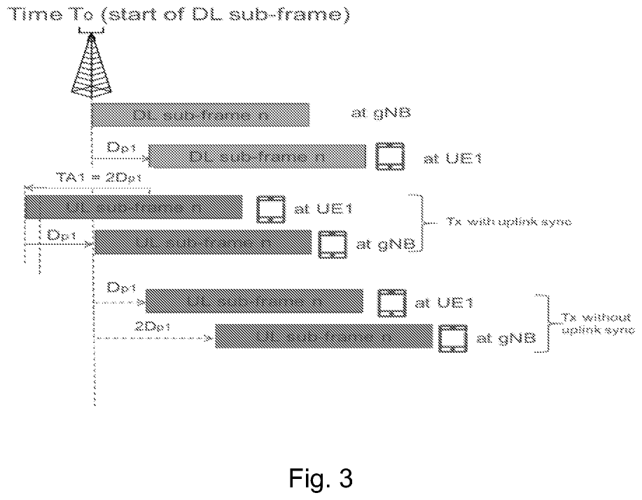

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WD) 610 are depicted with additional detail. Network node 660 may comprise a gNB or base station as described above with reference to FIGS. 1 to 5. Wireless device 610 may comprise a UE or wireless device as described above with reference to FIGS. 1 to 5. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

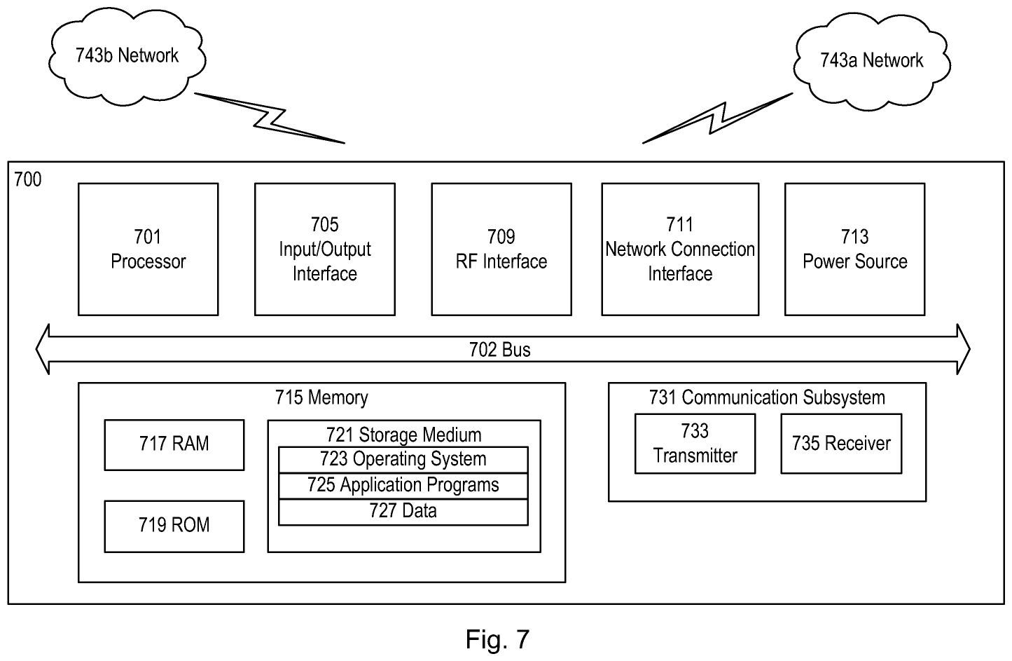

FIG. 7 illustrates a User Equipment in accordance with some embodiments

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 7200 may be any UE identified by the 3^{rd} Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa. UE 700 may comprise a UE or wireless device as described above with reference to FIGS. 1 to 5.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

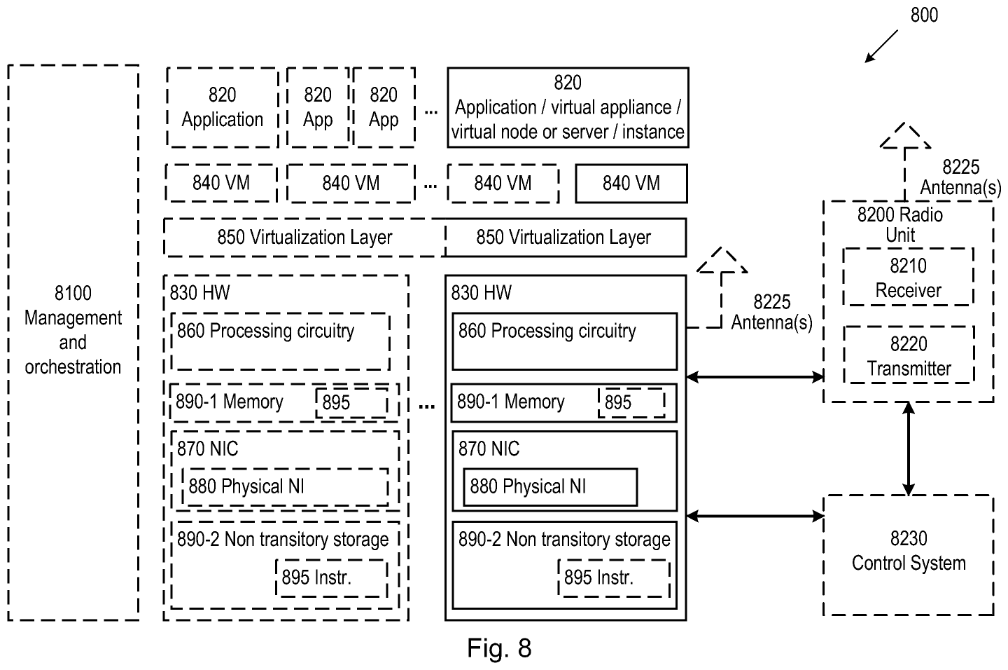

FIG. 8 illustrates a Virtualization environment in accordance with some embodiments

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

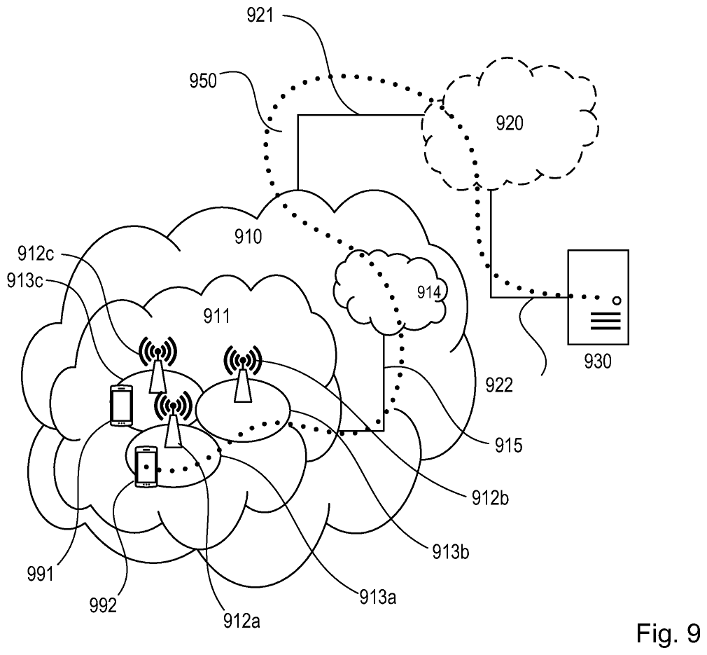

FIG. 9 illustrates a Telecommunication network connected via an intermediate network to a host computer in accordance with some embodiments.

With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

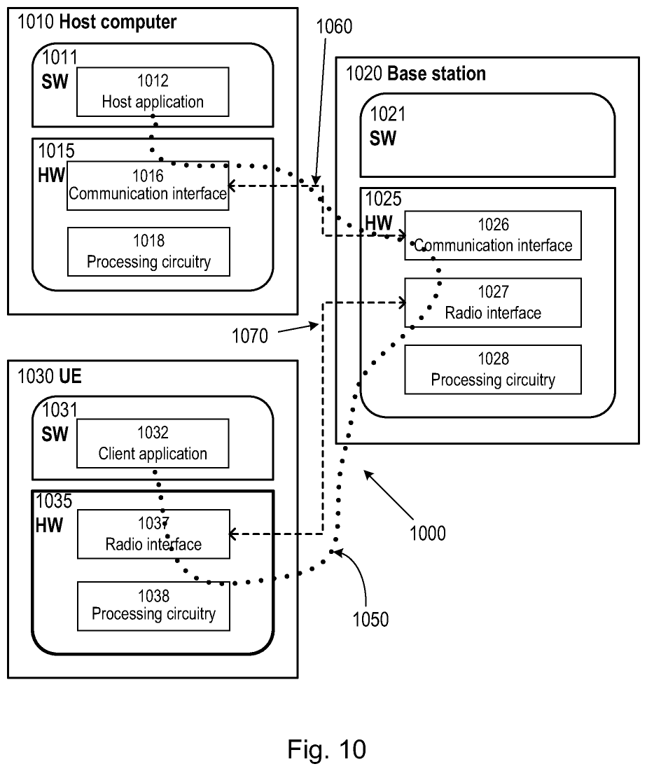

FIG. 10 illustrates a Host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment. More precisely, the teachings of these embodiments may improve a LBT blocking issues and thereby provide benefits such as better responsiveness.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

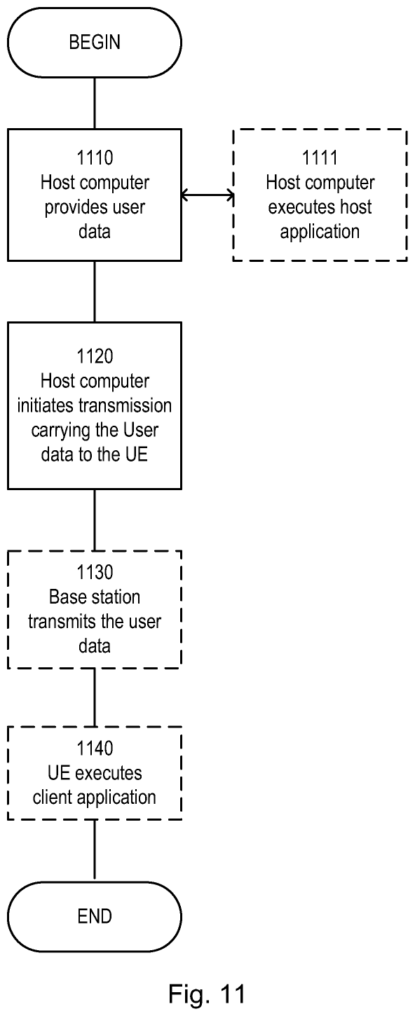

FIG. 11 illustrates methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

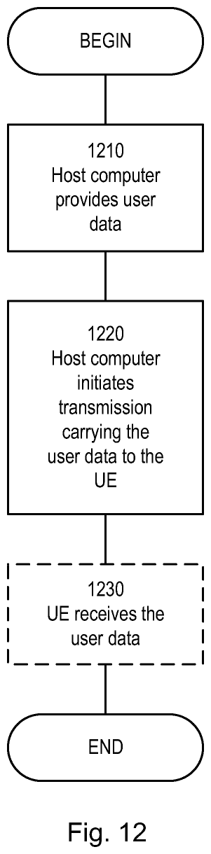

FIG. 12 illustrates methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

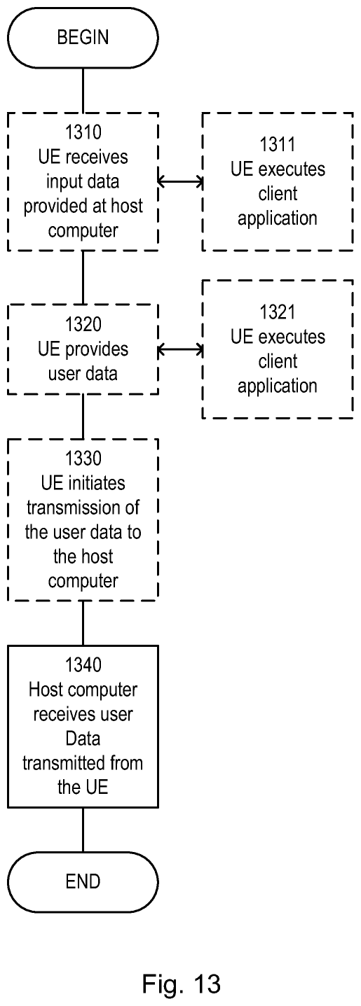

FIG. 13 illustrates methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

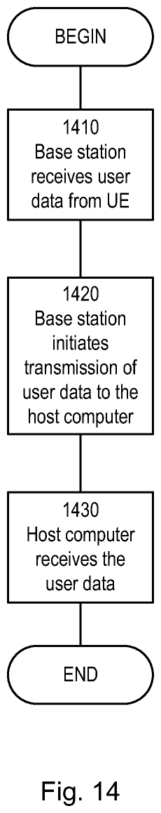

FIG. 14 illustrates methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

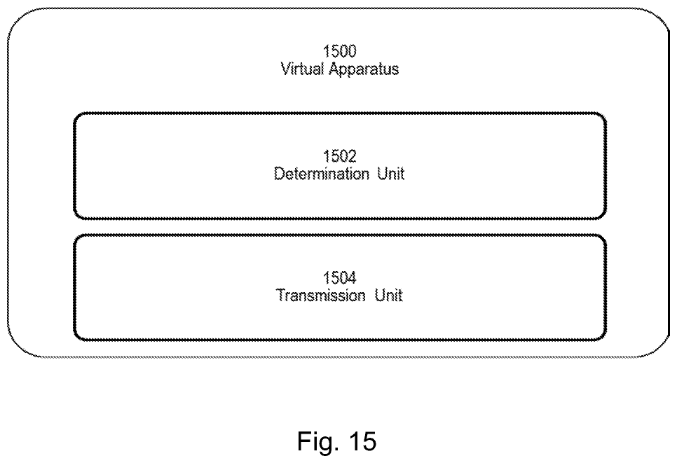

FIG. 15 illustrates a virtualization apparatus in accordance with some embodiments.

FIG. 15 illustrates a schematic block diagram of an apparatus 1500 in a wireless network (for example, the wireless network shown in FIG. 6). The apparatus may be implemented in a wireless device or network node (e.g., wireless device 610 or network node 660 shown in FIG. 6). Apparatus 1500 is operable to carry out the example method described with reference to FIG. 4 and possibly any other processes or methods disclosed herein. It is also to be understood that the method of FIG. 4 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Determination unit 1502, Transmission unit 1504, and any other suitable units of apparatus 1500 to perform corresponding functions according one or more embodiments of the present disclosure.

As illustrated in FIG. 15, apparatus 1500 includes Determination unit 1502, and Transmission unit 1504. Determination unit 1502 is configured to determine whether the uplink transmission comprises an urgent uplink transmission or a non-urgent uplink transmission. Transmission unit 1504 is configured to responsive to the uplink transmission comprising an urgent uplink transmission, transmit the uplink transmission to the base station, in particular after a successful LBT operation; and responsive to the uplink transmission comprising a non-urgent uplink transmission, transmit the non-urgent uplink transmission responsive to receiving a network scheduling message from the base station, wherein the network scheduling message indicates that the wireless device is scheduled for transmission of the non-urgent uplink transmission.

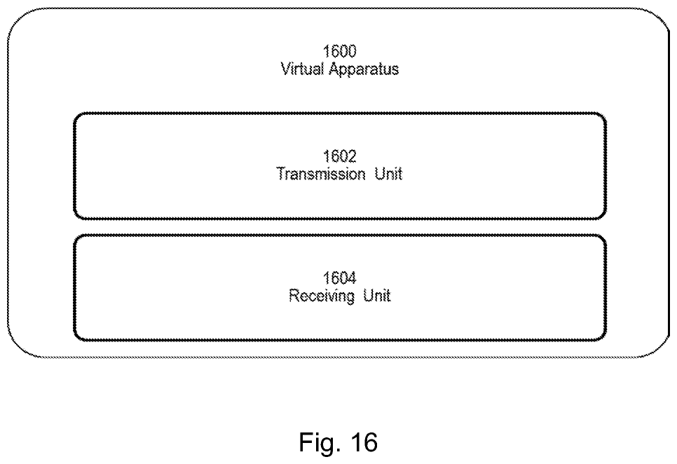

FIG. 16 illustrates a virtualization apparatus in accordance with some embodiments.

FIG. 16 illustrates a schematic block diagram of an apparatus 1600 in a wireless network (for example, the wireless network shown in FIG. 6). The apparatus may be implemented in a wireless device or network node (e.g., wireless device 610 or network node 660 shown in FIG. 6). Apparatus 1600 is operable to carry out the example method described with reference to FIG. 5 and possibly any other processes or methods disclosed herein. It is also to be understood that the method of FIG. 5 is not necessarily carried out solely by apparatus 1600. At least some operations of the method can be performed by one or more other entities.

Virtual Apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Transmission unit 1602, Receiving unit 1604, and any other suitable units of apparatus 1600 to perform corresponding functions according one or more embodiments of the present disclosure.

As illustrated in FIG. 16, apparatus 1600 includes Transmission unit 1602, and Receiving unit 1604. Transmission unit 1602 is configured to transmit a network scheduling message to a first wireless device, wherein the network scheduling message indicates that the first wireless device is scheduled for transmission of the non-urgent uplink transmission. Receiving unit 1604 is configured to responsive to transmitting the network scheduling message, receive the non-urgent uplink transmission from the first wireless device.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Embodiments

### Group A Embodiments

1. A method performed by a wireless device for transmitting an uplink transmission to a base station using an unlicensed frequency spectrum, the method comprising:
   determining whether the uplink transmission comprises an urgent uplink transmission or a non-urgent uplink transmission;
   responsive to the uplink transmission comprising an urgent uplink transmission, transmitting the uplink transmission to the base station; and
   responsive to the uplink transmission comprising a non-urgent uplink transmission, transmitting the non-urgent uplink transmission responsive to receiving a network scheduling message from the base station, wherein the network scheduling message indicates that the wireless device is scheduled for transmission of the non-urgent uplink transmission.
2. The method of embodiment 1, wherein the step of determining comprises determining whether the uplink transmission comprises an urgent uplink transmission or a non-urgent uplink transmission based on one or more of: a global indication of an application type, a logical channel priority of the uplink transmission, a quality class indicator of the uplink transmission, and a physical location of the wireless device.
3. The method of any preceding embodiment, wherein the step of determining comprises determining that the uplink transmission comprises an urgent uplink transmission responsive to the uplink transmission being triggered by a Radio Link Failure, a handover or a beam failure recovery, BFR.
4. The method of any preceding embodiment, wherein the network scheduling message indicates that the wireless device is scheduled for transmission of the non-urgent uplink transmission by identifying the wireless device.
5. The method of any preceding embodiment wherein the network scheduling message indicates that the wireless device is scheduled for transmission of the non-urgent uplink transmission by identifying a group of wireless devices, wherein the wireless device belongs to the group of wireless devices.
6. The method of any preceding embodiment wherein the network scheduling message indicates that the wireless device is scheduled for transmission of the non-urgent uplink transmission by identifying a type of uplink transmission, wherein the non-urgent uplink transmission is of the type of uplink transmission.
7. The method of any preceding embodiment, wherein the network scheduling message indicates a Listen Before Talk, LBT, category for the wireless device to use before transmitting the non-urgent uplink transmission.
8. The method of embodiment 7 wherein the network scheduling message indicates LBT parameters associated with the LBT category.
9. The method of any preceding embodiment further comprising:
   a. receiving network scheduling messages periodically.
10. The method of any one of embodiments 1 to 8 further comprising
   a. receiving the network scheduling message responsive to requesting scheduling as part of a Msg3 in a random access procedure.
11. The method of any one of embodiments 1 to 8 further comprising:
   a. receiving the network scheduling message as part of one of: a paging message, PDCCH signaling, RRC signaling or MAC CE.
12. The method of any preceding embodiment further comprising:
   responsive to the uplink transmission comprising a non-urgent uplink transmission, and responsive to not receiving a network scheduling message indicating that the wireless device is scheduled for transmission of the non-urgent uplink transmission in a predetermined time period, transmitting the non-urgent uplink transmission.
13. The method of any one of embodiments 1 to 11, further comprising:
   responsive to the uplink transmission comprising a non-urgent uplink transmission, and to not receiving a network scheduling message indicates that the wireless device is scheduled for transmission of the non-urgent uplink transmission, transmitting a request for scheduling as part of an urgent uplink transmission from the wireless device; and
   receiving a network scheduling message indicating that the wireless device should transmit the non-urgent uplink transmission responsive to the request.
14. The method of any preceding embodiment further comprising:
   responsive to receiving an indication that network scheduling messaging is disabled, transmitting the non-urgent uplink transmission without receiving a network scheduling message.
15. The method of any of the previous embodiments, further comprising:
   providing user data; and
   forwarding the user data to a host computer via the transmission to the base station.
16. The method of any of the previous embodiments further comprising:
   performing a clear channel assessment and, responsive to the channel being clear, transmitting the urgent uplink transmission.

### Group B Embodiments

17. A method performed by a base station for receiving an uplink transmission from at least one wireless device communicating with the base station using an unlicensed frequency spectrum, the method comprising:
   transmitting a network scheduling message to a first wireless device, wherein the network scheduling message indicates that the first wireless device is scheduled for transmission of the non-urgent uplink transmission;
   responsive to transmitting the network scheduling message, receiving the non-urgent uplink transmission from the first wireless device.
18. The method of embodiment 17, wherein the network scheduling message indicates that the first wireless device is scheduled for transmission of the non-urgent uplink transmission by identifying the first wireless device.
19. The method of embodiment 17 or 18 wherein the network scheduling message indicates that the first wireless device is scheduled for transmission of the non-urgent uplink transmission by identifying a group of wireless devices, wherein the first wireless device belongs to the group of wireless devices.
20. The method of embodiment 19 further comprising:
   a. configuring one or more groups of wireless devices based on timing advance values for the at least one wireless device communicating with the base station.
21. The method of embodiment 19 or 20 further comprising:
   a. determining one or more groups of wireless devices to configure based on a load on the base station.
22. The method of any one of embodiment 19 to 21 further comprising:
   a. transmitting an indication of the configured groups of wireless devices to the at least one wireless device communicating with the base station.
23. The method of any one of embodiment 17 to 22 wherein the network scheduling message indicates that the first wireless device is scheduled for transmission of the non-urgent uplink transmission by identifying a type of uplink transmission, wherein the non-urgent uplink transmission is of the type of uplink transmission.
24. The method of any of embodiments 17 to 23, wherein the network scheduling message indicates a Listen Before Talk, LBT, category for the first wireless device to use before transmitting the non-urgent uplink transmission.
25. The method of embodiment 24 wherein the network scheduling message indicates LBT parameters associated with the LBT category.
26. The method of any preceding embodiment further comprising:
   a. transmitting network scheduling messages periodically.
27. The method of any one of embodiments 17 to 25 further comprising
   a. transmitting the network scheduling message responsive to receiving a request for scheduling from the first wireless device as part of a Msg3 in a random access procedure.
28. The method of any one of embodiments 17 to 25 further comprising:
   a. transmitting the network scheduling message as part of one of: a paging message, PDCCH signaling, RRC signaling or MAC CE.
29. The method of any preceding embodiment further comprising:
   enabling or disabling the network scheduling based on a load on the base station.
30. The method of any of the previous embodiments, further comprising:
   obtaining user data; and
   forwarding the user data to a host computer or a wireless device.

### Group C Embodiments

31. A wireless device for transmitting an uplink transmission to a base station using an unlicensed frequency spectrum, the wireless device comprising:
   processing circuitry configured to perform any of the steps of any of the Group A embodiments; and
   power supply circuitry configured to supply power to the wireless device.
32. A base station for receiving an uplink transmission from at least one wireless device communicating with the base station using an unlicensed frequency spectrum, the base station comprising:
   processing circuitry configured to perform any of the steps of any of the Group B embodiments;
   power supply circuitry configured to supply power to the base station.
33. A user equipment (UE) for transmitting an uplink transmission to a base station using an unlicensed frequency spectrum, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
34. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
35. The communication system of the previous embodiment further including the base station.
36. The communication system of the previous 2 embodiments, further including the UE, wherein the UE is configured to communicate with the base station.
37. The communication system of the previous 3 embodiments, wherein:
   the processing circuitry of the host computer is configured to execute a host application, thereby providing the user data; and
   the UE comprises processing circuitry configured to execute a client application associated with the host application.
38. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
39. The method of the previous embodiment, further comprising, at the base station, transmitting the user data.
40. The method of the previous 2 embodiments, wherein the user data is provided at the host computer by executing a host application, the method further comprising, at the UE, executing a client application associated with the host application.
41. A user equipment (UE) configured to communicate with a base station, the UE comprising a radio interface and processing circuitry configured to performs the of the previous 3 embodiments.
42. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
43. The communication system of the previous embodiment, wherein the cellular network further includes a base station configured to communicate with the UE.
44. The communication system of the previous 2 embodiments, wherein:
   the processing circuitry of the host computer is configured to execute a host application, thereby providing the user data; and
   the UE's processing circuitry is configured to execute a client application associated with the host application.
45. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
46. The method of the previous embodiment, further comprising at the UE, receiving the user data from the base station.
47. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
48. The communication system of the previous embodiment, further including the UE.
49. The communication system of the previous 2 embodiments, further including the base station, wherein the base station comprises a radio interface configured to communicate with the UE and a communication interface configured to forward to the host computer the user data carried by a transmission from the UE to the base station.
50. The communication system of the previous 3 embodiments, wherein:
   the processing circuitry of the host computer is configured to execute a host application; and
   the UE's processing circuitry is configured to execute a client application associated with the host application, thereby providing the user data.
51. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
52. A method implemented in a communication system including a host computer, a base station and a user equipment (UE), the method comprising:
   at the host computer, receiving user data transmitted to the base station from the UE, wherein the UE performs any of the steps of any of the Group A embodiments.
53. The method of the previous embodiment, further comprising, at the UE, providing the user data to the base station.
54. The method of the previous 2 embodiments, further comprising:
   at the UE, executing a client application, thereby providing the user data to be transmitted; and
   at the host computer, executing a host application associated with the client application.
55. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
56. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
57. The communication system of the previous embodiment further including the base station.
58. The communication system of the previous 2 embodiments, further including the UE, wherein the UE is configured to communicate with the base station.
59. The communication system of the previous 3 embodiments, wherein:
   the processing circuitry of the host computer is configured to execute a host application;
   the UE is configured to execute a client application associated with the host application, thereby providing the user data to be received by the host computer.
60. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
61. The method of the previous embodiment, further comprising at the base station, receiving the user data from the UE.
62. The method of the previous 2 embodiments, further comprising at the base station, initiating a transmission of the received user data to the host computer.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1. A method in a wireless device for transmitting an uplink transmission to a base station using an unlicensed frequency spectrum, the method comprising:
determining whether the uplink transmission comprises an urgent uplink transmission or a non-urgent uplink transmission;
responsive to the uplink transmission comprising an urgent uplink transmission, transmitting the uplink transmission to the base station; and
responsive to the uplink transmission comprising a non-urgent uplink transmission, transmitting the non-urgent uplink transmission responsive to receiving a network scheduling message from the base station, wherein the network scheduling message indicates that the wireless device is scheduled for transmission of the non-urgent uplink transmission.

2. The method of claim 1, wherein the step of determining comprises determining whether the uplink transmission comprises an urgent uplink transmission or a non-urgent uplink transmission based on one or more of: a global indication of an application type, a logical channel priority of the uplink transmission, a quality class indicator of the uplink transmission, and a physical location of the wireless device.

3. The method of claim 1, wherein the step of determining comprises determining that the uplink transmission comprises an urgent uplink transmission responsive to the uplink transmission being triggered by a Radio Link Failure, a handover or a beam failure recovery, BFR.

4. The method of claim 1, wherein the network scheduling message indicates that the wireless device is scheduled for transmission of the non-urgent uplink transmission by identifying the wireless device; or
indicates that the wireless device is scheduled for transmission of the non-urgent uplink transmission by identifying a group of wireless devices, wherein the wireless device belongs to the group of wireless devices; or
indicates that the wireless device is scheduled for transmission of the non-urgent uplink transmission by identifying a type of uplink transmission, wherein the non-urgent uplink transmission is of the type of uplink transmission; or
indicates a Listen Before Talk, LBT, category for the wireless device to use before transmitting the non-urgent uplink transmission; or
indicates LBT parameters associated with the LBT category.

5-8. (canceled)

9. The method of claim 1 further comprising:
a. receiving network scheduling messages periodically.

10. The method of claim 1, further comprising:
a. receiving the network scheduling message responsive to requesting scheduling as part of a Msg3 in a random access procedure.

11. The method of claim 1 further comprising:
a. receiving the network scheduling message as part of one of: a paging message, PDCCH signaling, RRC signaling or MAC CE.

12. The method of claim 1 further comprising:
responsive to the uplink transmission comprising a non-urgent uplink transmission, and responsive to not receiving a network scheduling message indicating that the wireless device is scheduled for transmission of the non-urgent uplink transmission in a predetermined time period, transmitting the non-urgent uplink transmission.

13. The method of claim 1, further comprising:
responsive to the uplink transmission comprising a non-urgent uplink transmission, and to not receiving a network scheduling message indicates that the wireless device is scheduled for transmission of the non-urgent uplink transmission, transmitting a request for scheduling as part of an urgent uplink transmission from the wireless device; and
receiving a network scheduling message indicating that the wireless device should transmit the non-urgent uplink transmission responsive to the request.

14. The method of claim 1 further comprising:
responsive to receiving an indication that network scheduling messaging is disabled, transmitting the non-urgent uplink transmission without receiving a network scheduling message.

15. The method of claim 1 further comprising:
performing a clear channel assessment and, responsive to the channel being clear, transmitting the urgent uplink transmission.

16. A method in a base station for receiving an uplink transmission from at least one wireless device communicating with the base station using an unlicensed frequency spectrum, the method comprising:
transmitting a network scheduling message to a first wireless device, wherein the network scheduling message indicates that the first wireless device is scheduled for transmission of the non-urgent uplink transmission; and
responsive to transmitting the network scheduling message, receiving the non-urgent uplink transmission from the first wireless device.

17. The method of claim 16, wherein the network scheduling message indicates that the first wireless device is scheduled for transmission of the non-urgent uplink transmission by identifying the first wireless device; or
indicates that the first wireless device is scheduled for transmission of the non-urgent uplink transmission by identifying a group of wireless devices, wherein the first wireless device belongs to the group of wireless devices; or
indicates that the first wireless device is scheduled for transmission of the non-urgent uplink transmission by identifying a type of uplink transmission, wherein the non-urgent uplink transmission is of the type of uplink transmission; or
indicates a Listen Before Talk, LBT, category for the first wireless device to use before transmitting the non-urgent uplink transmission; or
indicates LBT parameters associated with the LBT category.

18. (canceled)

19. The method of claim 17 further comprising:
a. configuring one or more groups of wireless devices based on timing advance values for the at least one wireless device communicating with the base station.

20. The method of claim 17 further comprising:
a. determining one or more groups of wireless devices to configure based on a load on the base station.

21. The method of claim 17 further comprising:
a. transmitting an indication of the configured groups of wireless devices to the at least one wireless device communicating with the base station.

22-24. (canceled)

25. The method of claim 16 further comprising:
transmitting network scheduling messages periodically; or
transmitting the network scheduling message responsive to receiving a request for scheduling from the first wireless device as part of a Msg3 in a random access procedure; or
transmitting the network scheduling message as part of one of: a paging message, PDCCH signaling, RRC signaling or MAC CE.

26. (canceled)

27. (canceled)

28. The method of claim 16 further comprising:
enabling or disabling the network scheduling based on a load on the base station.

29. A wireless device for transmitting an uplink transmission to a base station using an unlicensed frequency spectrum, the wireless device comprising:
a processor and a memory, the memory having instructions, which executed by the processor to cause the wireless device to:
determine whether the uplink transmission comprises an urgent uplink transmission or a non-urgent uplink transmission;
responsive to the uplink transmission comprising an urgent uplink transmission, transmit the uplink transmission to the base station; and
responsive to the uplink transmission comprising a non-urgent uplink transmission, transmit the non-urgent uplink transmission responsive to receiving a network scheduling message from the base station, wherein the network scheduling message indicates that the wireless device is scheduled for transmission of the non-urgent uplink transmission.

30-32. (canceled)
